(19) United States
(12) Patent Application Publication
(10) Pub. No.: US 2020/0399515 A1
(43) Pub. Date: Dec. 24, 2020

(54) AEROSOL COMPOSITIONS

(71) Applicant: THE CHEMOURS COMPANY FC, LLC, WILMINGTON, DE (US)

(72) Inventor: MARK L ROBIN, MIDDLETOWN, DE (US)

(73) Assignee: THE CHEMOURS COMPANY FC, LLC, WILMINGTON, DE (US)

(21) Appl. No.: 16/765,032

(22) PCT Filed: Nov. 20, 2018
(86) PCT No.: PCT/US2018/062046

§ 371 Date: May 18, 2020

Related U.S. Application Data
(60) Provisional application No. 62/590,847, filed on Nov. 27, 2017.

(51) Int. Cl. C09K 3/30; C11D 17/00; C11D 7/50

(52) U.S. Cl. CPC C09K 3/30; B65D 83/752; C11D 7/5068; C11D 17/0043

(57) ABSTRACT

The present application provides liquefied-gas aerosol compositions which are useful in for preventing incidents of inhalation abuse. The compositions described herein comprise, for example, i) a propellant component comprising one or more hydrohaloolefins; and ii) one or more bitterants.

### CROSS-REFERENCE TO RELATED APPLICATIONS

This application claims the benefit of U.S. Provisional Application Ser. No. 62/590,847, filed Nov. 27, 2017, the disclosure of which is incorporated herein by reference in its entirety.

### TECHNICAL FIELD

The present disclosure relates to liquefied-gas aerosol compositions comprising a propellant component comprising one or more hydrohaloolefins; and one or more bitterants, for use in for preventing incidents of inhalation abuse.

### BACKGROUND

Liquefied-gas aerosol dusters provide a safe, useful, convenient, and economically efficient means of cleaning dust and debris from hard to reach places, where it can be harmful or detrimental. This can be especially true for the multitude of electronic equipment used today, where small foreign particles can render expensive equipment inoperable or shorten its useful life. These aerosol dusters provide an available source of pressurized gas that can be used to remove such debris. Packaged in appropriately designed aerosol cans, the liquefied gas and aerosol package components can be chosen so as to deliver a pressurized burst of gas, for example, in a preferred cleaning pattern. The aerosol valve and actuator can be configured to deliver the appropriate amount of gas at the right pressure in a range from broad to pinpoint spray patterns. Using liquefied gases provides an ample supply of material for a large number of cleaning tasks in a compact package.

### SUMMARY

The present application provides, inter alia, an aerosol composition, comprising:
i) a propellant component comprising one or more hydrohaloolefins; and
ii) one or more bitterants,
   wherein constituent members are defined herein.

The present application further provides methods of using the aerosol compositions of the invention, for example, in methods of cleaning a substrate and methods of cleaning an electronic device, comprising spraying a composition provided herein onto the substrate or device.

Unless otherwise defined, all technical and scientific terms used herein have the same meaning as commonly understood by one of ordinary skill in the art to which this invention belongs. Methods and materials are described herein for use in the present invention; other, suitable methods and materials known in the art can also be used. The materials, methods, and examples are illustrative only and not intended to be limiting. All publications, patent applications, patents, sequences, database entries, and other references mentioned herein are incorporated by reference in their entirety. In case of conflict, the present specification, including definitions, will control.

### DETAILED DESCRIPTION

The present application provides a liquefied-gas aerosol dusting composition, useful for discouraging incidents of inhalation abuse. The compositions provided herein comprise at least one liquefied hydrohaloalkene gas component (i.e., at least one halofluoroolefin, at least one halochloroolefin, or a mixture thereof), and a bitterant component. When the liquefied-gas aerosol dusting composition forms a liquid-vapor phase equilibrium in a container (e.g., an aerosol container), the bitterant concentration in the vapor phase is lower than the bitterant concentration in the liquid phase. In addition, when the liquefied-gas aerosol dusting composition packaged in an aerosol container is consumed and discharged as a vapor, the bitterant concentration in the liquid phase of the remaining composition in the can will increase, and consequently so will the bitterant in the vapor phase. The compositions of the invention are surprisingly stable, particularly when considering the reactivity of the double bond moiety of the hydrohaloalkene component, which may have been expected to react in the presence of the bitterant agent in the compositions.

Manufacturers and suppliers of liquified-aerosol gas compositions expend significant resources and energy toward good product stewardship with goals of providing products that are safe when used as intended. While these products provide a safe and valuable function to the consumer, there is an associated risk of inhalation abuse incidents. It is therefore useful to design new sprayable aerosol compositions with components to discourage such practices. One such approach is to incorporate a denaturant (e.g., a bitterant) in the composition that can be detected in an abuse scenario, but undetectable when the product is used as recommended.

Denatonium benzoate is an acutely bitter substance that can be detected by human taste at concentrations as low as 50 ppb. Thus, denatonium benzoate can be used as a denaturant (see e.g., European Patent Number EP0884377B1 for an exemplary use of denatomium benzoate as a denaturant). However, when the concentration of denatonium benzoate in the liquefied-gas aerosol composition is too high, the denatonium benzoate can interfere with normal product use. When the concentration of denatonium benzoate in the liquefied-gas aerosol composition is too low, it becomes ineffective as a deterrent to accidental or intentional misuses.

There is a need for a liquefied-gas aerosol dusting composition with a bittering additive agent that does not interfere with normal product use but is detectable in an inhalation abusive scenario so as to potentially discourage the practice. There is also a need for a liquefied dusting composition with a bittering additive agent whose use does not contribute significantly to climate change. For example, U.S. Pat. No. 7,754,096 describes the use of a bitterant in a liquefied gas aerosol consisting of HFC-134a, however, the use of HFC-134a in aerosol products is scheduled for an eventual phase-out due to the high global warming potential (GWP) of HFC-134a. Accordingly, the compositions of the inventions comprise a propellant component comprising one or more hydrohaloolefins, which exhibit its low GWP, and in some cases non-flammability, high efficiency, and thermal stability (e.g., HFO-1336mzz-Z, HFO-1336mzz-E).

### Definitions and Chemical Abbreviations

The term “compound” as used herein is meant to include all stereoisomers, geometric isomers, tautomers, and isotopes of the structures depicted. Compounds herein identified by name or structure as one particular tautomeric form are intended to include other tautomeric forms unless otherwise specified.

As used herein, an azeotropic composition (i.e., an azeotrope or azeotrope composition) refers to an admixture of two or more different components which, when in liquid form and (1a) under a given constant pressure, will boil at a substantially constant temperature, which temperature may be higher or lower than the boiling temperatures of the individual components, or (1b) at a given constant temperature, will boil at a substantially constant pressure, which pressure may be higher or lower than the boiling pressure of the individual components, and (2) will boil at substantially constant composition, which phase compositions, while constant, are not necessarily equal. (see, e.g., M. F. Doherty and M. F. Malone, Conceptual Design of Distillation Systems, McGraw-Hill (New York), 2001, 185).

A homogeneous azeotrope, in which a single vapor phase is in equilibrium with a single liquid phase, has, in addition to properties (1a), (1b), and (2) above, the property that the composition of each component is the same in each of the coexisting equilibrium phases. The general term “azeotrope” is a commonly used alternative name for a homogeneous azeotrope.

A heterogeneous azeotrope, in which a single vapor phase is in equilibrium with two liquid phases, has properties (1a), (1b), and (2) as described above where, while constant, the three coexisting equilibrium phases each have different compositions (See e.g., M. F. Doherty and M. F. Malone, Conceptual Design of Distillation Systems, McGraw-Hill (New York), 2001, 352). At the heterogeneous azeotrope, the composition of the overall liquid phase, (i.e., the liquid phase composition obtained by combining the two equilibrium liquid phases), is identical to the composition of the equilibrium vapor phase.

As used herein, an “azeotrope-like” composition refers to a composition that behaves like an azeotropic composition (i.e., has constant boiling characteristics or a tendency not to fractionate upon boiling or evaporation). Hence, during boiling or evaporation, the vapor and liquid compositions, if they change at all, change only to a minimal or negligible extent. In contrast, the vapor and liquid compositions of non-azeotrope-like compositions change to a substantial degree during boiling or evaporation.

As used herein, the terms “azeotrope-like” or “azeotrope-like behavior” refer to compositions that exhibit dew point pressure and bubble point pressure with virtually no pressure differential. In some embodiments, the difference in the dew point pressure and bubble point pressure at a given temperature is 3% or less. In some embodiments, the difference in the bubble point and dew point pressures is 5% or less.

Global warming potential (GWP) is an index for estimating relative global warming contribution due to atmospheric emission of a kilogram of a particular greenhouse gas compared to emission of a kilogram of carbon dioxide. GWP can be calculated for different time horizons showing the effect of atmospheric lifetime for a given gas. The GWP for the 100-year time horizon is commonly the value referenced.

The term “a liquefied gas” is intended to mean a chemical compound or a mixture of chemical compounds that is in a liquid state under pressure. Such chemical compound or such mixture of chemical compounds is in a gaseous state at about 25° C. and atmospheric pressure.

The term “hydrohaloalkene” is intended to mean a chemical compound selected from the classes of hydrofluoroolefins (HFOs) and hydrochlorofluoroolefins (HCFOs). Representative HFOs include, but are not limited to, HFO-1336mzz-E (E-CF₃CH═CHCF₃), HFO-1336mzz-Z (Z—CF₃CH═CHCF₃), HFO-1234yf (CF₃CF═CH₂), HFO-1234ze-E (E-CF₃CH═CHF) and HFO-1234ze-Z (Z—CF₃CF═CHF). Representative HCFOs include, but are not limited to, HCFO-1233zd-E (E-CF₃CH═CHCl), HCFO-1233zd-Z (Z—CF₃CH═CHCl), HCFO-1224yd-E (E-CF₃CF═CHCl), and HCFO-1224yd-Z (Z—CF₃CF═CHCl).

The term “denatonium benzoate” refers to the compound N-[2-[(2,6-Dimethylphenyl)amino]-2-oxoethyl]-N,N-diethylbenzenemethanaminium benzoate with CAS number of 3734-33-6. Denatonium benzoate is commercially available, e.g. from Sigma-Aldrich Corp. in Milwaukee, Wis.

The term “denatonium saccharide” refers to the compound benzyldiethyl-[(2,6-xylylcarbamoyl)methyl]-ammonium saccharide with CAS number of 90823-38-4. Denatonium saccharide is commercially available, e.g. from Aversion Technologies, Inc. in Bowie, Md.

The term “sucrose octaacetate” refers to the compound 1,3,4,6-tetra-O-acetyl-beta-D-Frutofuranosyl, tetraacetate with CAS number of 126-14-7. Sucrose Octaacetate is commercially available, e.g. from Spectrum Laboratory Products, Gardena, Calif.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Although methods and materials similar or equivalent to those described herein can be used in the practice or testing of embodiments of the present invention, suitable methods and materials are described below. All publications, patent applications, patents, and other references mentioned herein are incorporated by reference in their entirety, unless a particular passage is cited. In case of conflict, the present specification, including definitions, will control. In addition, the materials, methods, and examples are illustrative only and not intended to be limiting.

### Chemicals, Abbreviations, and Acronyms

HFO-1336mzz-E: (E)-1,1,1,4,4,4-hexafluorobut-2-ene ((E)-CF₃CH═CHCF₃)
HFO-1336mzz-Z: (Z)-1,1,1,4,4,4-hexafluorobut-2-ene ((Z)—CF₃CH═CHCF₃)
HFO-1234yf: 2,3,3,3-tetrafluoroprop-1-ene (CF₃CF═CH₂)
HFO-1234ze-E: (E)-1,3,3,3-tetrafluoroprop-1-ene ((E)-CF₃CH═CHF)
HFO-1234ze-Z: (Z)-1,3,3,3-tetrafluoroprop-1-ene (((Z)—CF₃CH═CHF)
HCFO-1233zd-E: (E)-1-chloro-3,3,3-trifluoroprop-1-ene ((E)-CF₃CH═CHCl)
HCFO-1233zd-Z: (Z)-1-chloro-3,3,3-trifluoroprop-1-ene ((Z)—CF₃CH═CHCl)
HCFO-1224yd-E: (E)-1-chloro-2,3,3,3-tetrafluoroprop-1-ene ((E)-CF₃CF═CHCl)
HCFO-1224yd-Z: (Z)-1-chloro-2,3,3,3-tetrafluoroprop-1-ene ((Z)—CF₃CF═CHCl))
HFC-134: 1,1,2,2-tetrafluoroethane (CHF₂CHF₂)
HFC-134a: 1,1,1,2-tetrafluoroethane (CF₃CH₂F)
HFC-152a: 1,1-difluoroethane (CH₃CHF₂)
HFO-1438ezy-E: (E)-1,3,4,4,4-pentafluoro-3-(trifluoromethyl)but-1-ene ((E)-(CF₃)₂CFCH═CHF)
HFO-1438ezy-Z: (Z)-1,3,4,4,4-pentafluoro-3-(trifluoromethyl)but-1-ene ((Z)—(CF₃)₂CFCH═CHF)
E-F-11E oxide: (E)-2,3-bis(trifluoromethyl)oxirane
E-F-11E oxide: (Z)-2,3-bis(trifluoromethyl)oxirane
E-F-12E oxide: (E)-2-(trifluoromethyl)-3-(pentafluoroethyl)oxirane
E-F-12E oxide: (Z)-2-(trifluoromethyl)-3-(pentafluoroethyl)oxirane
CFO-1112: 1,2-dichloro-1,2-difluoroethene (CFCl═CFCl)
CFC: chlorofluorocarbon
HCFC: hydrochlorofluorocarbon
HFC: hydrofluorocarbon
HFO: hydrofluoroolefin
HCFO: hydrochlorofluoroolefin
ppm: parts per million by weight
ppb: parts per billion by weight

### Compositions of the Invention and Uses Thereof

The present application provides, inter alia, an aerosol composition, comprising:
i) a propellant component comprising one or more hydrohaloolefins; and
ii) one or more bitterants.

In some embodiments, the aerosol composition is a sprayable aerosol composition.

The propellant component (i.e., the one or more hydrohaloolefins) of the compositions of the invention can be sprayed together with one or more additional inert ingredients, solvents, and other active components present in the compositions.

In some embodiments, the composition further comprises a solvent component, a carrier gas component, or a combination thereof.

In some embodiments, the solvent component, carrier gas component, or combination thereof, is first mixed with the propellant component to form a propellant mixture, and the bitterant is dissolved in said mixture. Exemplary solvent components (e.g., HFCs, HFOs, and HCs) such as propellants can be blended with the hydrohaloolefin propellant component of the compositions to provide effective delivery of water- or organic solvent-based products. For example, dimethylether (DME) is particularly soluble in water.

In some embodiments, the solvent component is a water soluble solvent (e.g., DME).

In some embodiments, the solvent component is a hydrocarbon soluble solvent (e.g., a HFC, a HC).

In some embodiments, the solvent component is selected from an alcohol, a hydrocarbon, a hydrofluorocarbon, dimethyl ether (DME), E-2-fluoro-3-(trifluoromethyl)oxirane, E-F-11E oxide, E-F-12E oxide, CFO-1112, or any mixture thereof.

In some embodiments, the alcohol is a C₁₋₆ alcohol. As used here, the term “C₁₋₆ alcohol” refers to a saturated hydrocarbon group (i.e., an alkyl group) that may be straight-chain or branched, having 1 to 6 carbon atoms, which is substituted by one or more hydroxyl (OH) groups. In some embodiments, the C₁₋₆ alcohol comprises one OH group. Exemplary C₁₋₆ alcohols include, but are not limited to methanol, ethanol, propanol, n-butanol, tert-butanol, and the like.

In some embodiments, the solvent component is an alcohol selected from methanol, ethanol, propanol, and isopropanol.

In some embodiments, the solvent component is a hydrocarbon selected from propane, n-butane, isobutane, n-pentane, isopentane, and cyclopentane.

In some embodiments, the solvent component is a hydrofluorocarbon which is selected from HFC-152a, HFC-134, and HFC-134a.

In some embodiments, the carrier gas component is selected from one of more of nitrogen, carbon dioxide, and nitrous oxide.

In some embodiments, the propellant component comprises one or more hydrofluoroolefins.

In some embodiments, the propellant component comprises one or more hydrofluoroolefins independently selected from HFO-1336mzz-E, HFO-1336mzz-Z, HFO-1234yf, HFO-1234ze-E, HFO-1234ze-Z, and HFO-1438ezy-E.

In some embodiments, the propellant component comprises one or more hydrofluorolefins selected from HFO-1336mzz-E and HFO-1336mzz-Z.

In some embodiments, the propellant component comprises a mixture of hydrofluoroolefins in an amount sufficient to form an azeotropic mixture or an azeotrope-like mixture. Azeotrope and azeotrope-like propellants offer certain advantageous properties (see e.g., P. A. Sanders, Handbook of Aerosol Technology, Second Edition, Robert A. Krieger Publishing Company (Malabar Fla.), 1987, 41). The composition of the vapor phase is the same as that in the liquid phase in such mixtures. Therefore, when azeotrope or azeotrope-like mixtures are used, the composition of the liquid phase remains constant during aerosol product discharge. This is a considerable advantage for products such as dry-type antiperspirants, since the properties of the spray do not change with time. Exemplary azeotropic and azeotrope-like mixtures comprising representative hydrohaloolefins, HFO-1336mzz-Z (i.e., Z-1336mzz) and HFO-1336mzz-E (i.e., E-1336mzz), are shown below in Tables A-B.

TABLE A

| | Azeotrope Mixture | | Azeotrope-like Mixture | |
|---|---|---|---|---|
| | | Boiling | | Boiling |
| | | point | | point |
| | Mole % | @ 1 atm | Mole % | @ 1 atm |
| Component | Z-1336mzz | (° C.) | Z-1336mzz | (° C.) |
| n-Pentane | 50.8 | 22.5 | 42-61 | 22-23 |
| iso-Pentane | 41.1 | 18.6 | 31-50 | 19 |
| Cyclopentane | 63.5 | 26.7 | 57-76 | 27 |
| HCFO-1233zd-E | — | — | 0-33; | 18-20; |
| | | | 93-100 | 31-33 |
| E-1336mzz | — | — | 0-10; | 8-9; |
| | | | 96-100 | 31-33 |
| n-butane | 12.0 | −1.9 | 0-18 | −1-−2 |
| isobutane | 3.9 | −12 | 0-10 | −12 |
| HFO-1438ezy-E | 36.2 | 29.5 | 0-100 | 29-33 |

TABLE B

| | Azeotrope Mixture | | Azeotrope-like Mixture | |
|---|---|---|---|---|
| | | Boiling | | Boiling |
| | | point | | point |
| | Mole % | @ 1 atm | Mole % | @ 1 atm |
| Component | E-1336mzz | (° C.) | E-1336mzz | (° C.) |
| n-pentane | 83.4 | 6.2 | 73-99 | 6-7 |
| isopentane | 76.0 | 5.1 | 64-99 | 5-7 |
| n-butane | 35.0 | −6.5 | 1-3; | −1-−2 |
| | | | 21-47 | −6-−7 |
| isobutane | 21.8 | −14 | 1-31 | −12-−14 |
| HCFO-1233zd-E | — | — | 1-16; | 15-18; |
| | | | 43-99 | 8-11 |
| HFO-1438ezy-E | — | — | 1-8; | 7-9; |
| | | | 94-99 | 29-31 |
| Z-1336mzz | — | — | 90-99; | 8-9 |
| | | | 1-4 | 31-33 C. |

In some embodiments, the composition comprises a propellant component which is HFO-1336mzz-Z and one or more solvent components selected from n-pentane, iso-pentane, cyclopentane, n-butane, iso-butane, and HFO-1438ezy-E, wherein the propellant component and one or more solvent components are present in the composition in an amount sufficient to form an azeotrope or an azeotrope-like composition.

In some embodiments, the composition comprises a propellant component which is HFO-1336mzz-E and one or more solvent components selected from n-pentane, iso-pentane, cyclopentane, n-butane, iso-butane, HCFO-1233zd-E and HFO-1438ezy-E, wherein the propellant component and one or more solvent components are present in the composition in an amount sufficient to form an azeotrope or an azeotrope-like composition.

In some embodiments, the propellant component comprises a mixture of:
HFO-1336mzz-Z and HFO-1336mzz-E; or
HFO-1336mzz-Z and HFO-1438ezy-E; or
HFO-1336mzz-E and HFO-1438ezy-E.

In some embodiments, the propellant component comprises a mixture of:
HFO-1336mzz-Z and HFO-1336mzz-E; or
HFO-1336mzz-Z and HFO-1438ezy-E; or
HFO-1336mzz-E and HFO-1438ezy-E;
   wherein the mixture is an azeotrope-like mixture.

In some embodiments, the propellant component comprises one or more hydrochlorofluoroolefins selected from HCFO-1233zd-E, HCFO-1233zd-Z, HCFO-1224yd-E and HCFO-1224yd-Z.

In some embodiments, the propellant component comprises a mixture of one or more hydrofluoroolefins selected from HFO-1336mzz-E, HFO-1336mzz-Z, HFO-1234yf, HFO-1234ze-E, HFO-1234ze-Z, and HFO-1438ezy-E, and one or more hydrochlorofluoroolefins selected from HCFO-1233zd-E, HCFO-1233zd-Z, HCFO-1224yd-E and HCFO-1224yd-Z.

In some embodiments, the propellant component comprises a mixture of hydrofluoroolefins and hydrochlorofluoroolefins in an amount sufficient to form an azeotropic mixture or azeotrope-like mixture.

In some embodiments, the propellant component comprises a mixture of:
HFO-1336mzz-Z and HCFO-1233zd; or
HFO-1336mzz-E and HCFO-1233zd.

In some embodiments, the propellant component comprises a mixture of:
HFO-1336mzz-Z and HCFO-1233zd; or
HFO-1336mzz-E and HCFO-1233zd;
   wherein the mixture is an azeotrope-like mixture.

In some embodiments, the propellant component comprises a mixture of hydrofluoroolefins and one or more solvent components, carrier gas components, or a combination thereof, in an amount sufficient to form an azeotropic mixture or an azeotrope-like mixture.

In some embodiments, the propellant component comprises a mixture of hydrofluoroolefins, hydrochlorofluoroolefins, and one or more solvent components, carrier gas components, or a combination thereof, in an amount sufficient to form an azeotropic mixture or an azeotrope-like mixture.

In some embodiments, the propellant component and the solvent component are present in an amount sufficient to form an azeotropic mixture or an azeotrope-like mixture.

In some embodiments, the propellant component and the carrier gas component are present in an amount sufficient to form an azeotropic mixture or an azeotrope-like mixture.

In some embodiments, the composition comprises a propellant component which is HFO-1336mzz-Z or HFO-1336mzz-E, and a solvent component selected from n-pentane, iso-pentane, cyclopentane, n-butane, isobutane, and dimethyl ether, wherein the propellant component and solvent component are present in an amount sufficient to form an azeotropic mixture or an azeotrope-like mixture.

In some embodiments, the propellant component is a liquid.

In some embodiments, the one or more bitterants are each independently selected from denatonium benzoate, denatonium saccharide, denatonium 4-vinylbenzoate, sucrose octaacetate, gentian, naringin, limonin, quercetin analogs, phenolics, and quassin. Examples of quercetin analogs and phenolics that may be useful as bitterants in the compositions of the invention can be found, for example, in U.S. Patent Application Publication No.: 2014-0371411, the disclosure of which is incorporated herein by reference in its entirety.

In some embodiments, the one or more bitterants are each independently selected from denatonium benzoate, denatonium saccharide, and sucrose octaacetate.

In some embodiments, the composition comprises a bitterant which is denatonium benzoate.

In some embodiments, the concentration of the bitterant in the composition provided herein is from about 5 ppm to about 50 ppm, for example, about 5 ppm to about 40 ppm, about 5 ppm to about 30 ppm, about 5 ppm to about 20 ppm, about 5 ppm to about 10 ppm, about 10 ppm to about 50 ppm, about 10 ppm to about 40 ppm, about 10 ppm to about 30 ppm, about 10 ppm to about 20 ppm, about 20 ppm to about 50 ppm, about 20 ppm to about 40 ppm, about 20 ppm to about 30 ppm, about 30 ppm to about 50 ppm, about 30 ppm to about 40 ppm, or about 40 ppm to about 50 ppm.

In some embodiments, the concentration of bitterant in the composition is from about 5 ppm to about 50 ppm.

In some embodiments, the composition provided herein comprises:
a propellant component which is HFO-1234ze-E and a bitterant which is denatonium benzoate; or
a propellant component which is HFO-1336mzz-E and a bitterant which is denatonium benzoate; or
a propellant component which is HFO-1336mzz-Z and a bitterant which is denatonium benzoate.

In some embodiments, the composition provided herein comprises:
a propellant component which is HFO-1234ze-E, a bitterant which is denatonium benzoate, and a solvent component which is ethanol; or
a propellant component which is HFO-1336mzz-E, a bitterant which is denatonium benzoate, and a solvent component which is isobutane; or
a propellant component which is HFO-1336mzz-E, a bitterant which is denatonium benzoate, and a solvent component which is dimethyl ether; or
a propellant component which is HFO-1336mzz-E, a bitterant which is denatonium benzoate, and a solvent component which is HFC-152a; or
a propellant component which is HFO-1336mzz-Z, a bitterant which is denatonium benzoate, and a solvent component which is isobutane; or
a propellant component which is HFO-1336mzz-Z, a bitterant which is denatonium benzoate, and a solvent component which is dimethyl ether.

In some embodiments, the composition provided herein comprises from about 5 to about 50 percent by weight of the hydrohaloolefin, for example, about 5 to about 40, about 5 to about 30, about 5 to about 20, about 5 to about 10, about 10 to about 50, about 10 to about 40, about 10 to about 30, about 10 to about 20, about 20 to about 50, about 20 to about 40, about 20 to about 30, about 30 to about 50, about 30 to about 40, or about 40 to about 50 percent by weight of the hydrohaloolefin.

In some embodiments, the composition comprises from about 95 to about 50 percent by weight of a solvent component, carrier gas component, or a combination thereof, for example, about 95 to about 60, about 95 to about 70, about 95 to about 80, about 95 to about 90, about 90 to about 50, about 90 to about 60, about 90 to about 70, about 90 to about 80, about 80 to about 50, about 80 to about 60, about 80 to about 70, about 70 to about 50, about 70 to about 60, or about 60 to about 50 weight percent of a solvent component, carrier gas component, or a combination thereof.

In some embodiments, the composition provided herein comprises:
about 95 to about 99.99 percent by weight of a propellant component which is HFO-1234ze-E, about 5 to about 0.01 percent by weight of a solvent component which is ethanol, and a bitterant which is denatonium benzoate;
about 40 to about 50 percent by weight of a propellant component which is HFO-1336mzz-E, about 60 to about 50 percent by weight of a solvent component which is isobutane, and a bitterant which is denatonium benzoate;
about 20 to about 30 percent by weight of a propellant component which is HFO-1336mzz-E, about 80 to about 70 percent by weight of a solvent component which is dimethyl ether, and a bitterant which is denatonium benzoate;
about 5 to about 15 percent by weight of a propellant component which is HFO-1336mzz-E, about 95 to about 85 percent by weight of a solvent component which is isobutane, and a bitterant which is denatonium benzoate;
about 15 to about 25 percent by weight of a propellant component which is HFO-1336mzz-E, about 85 to about 75 percent by weight of a solvent component which is HFC-152a, and a bitterant which is denatonium benzoate;
about 20 to about 30 percent by weight of a propellant component which is HFO-1336mzz-Z, about 80 to about 70 percent by weight of a solvent component which is isobutane, and a bitterant which is denatonium benzoate;
about 20 to about 30 percent by weight of a propellant component which is HFO-1336mzz-Z, about 80 to about 70 percent by weight of a solvent component which is dimethyl ether, and a bitterant which is denatonium benzoate;

In some embodiments, the present application provides a method of cleaning a substrate, comprising spraying a composition provided herein onto the substrate.

In some embodiments, the present application provides a method of cleaning an electronic device, comprising spraying a composition provided herein onto the device.

In some embodiments, the compositions provided herein further comprise an active component suitable for spraying. Suitable active components to be sprayed include, but are not limited to, cosmetic agents (e.g., deodorants, perfumes, hair sprays, and cleaners), polishing agents, and medicinal agents (e.g., anti-asthma or anti-halitosis agents).

The present application further provides a method of delivering an active component onto a surface, comprising spraying the sprayable aerosol composition of the invention, wherein the composition comprises the active component.

The present invention further provides a process for preparing the aerosol compositions described herein, the process comprising the step of adding the propellant component and bitterant as described herein to one or more active components in a container (e.g., an aerosol container).

In some embodiments, the one or more bitterants are dissolved in the propellant component of the composition. In some embodiments, the one or more bitterants are first dissolved in a solvent component, then the resulting solution is further mixed with the propellant component to form the composition of the invention. The bitterants can be dissolved in propellant component or solvent component by suitable means which are standard in the art, such as mechanical mixing.

In some embodiments, the aerosol composition is packaged in an aerosol container equipped with an aerosol valve that has no dip tube. When the valve is actuated for normal use, vapor is discharged and the liquefied gas (i.e., the propellant component, optionally in combination with a solvent component, carrier gas component, or a combination thereof) evaporates to re-establish equilibrium pressure in the can.

### EXAMPLES

The invention will be described in greater detail by way of specific examples. The following examples are offered for illustrative purposes and are not intended to limit the invention in any manner. Those of skill in the art will readily recognize a variety of non-critical parameters which can be changed or modified to yield essentially the same results.

### Example 1. Aerosol Composition of HFO-1234ze-E and Denatonium Benzoate

The Examples described herein were conducted in glass aerosol bottles. HFO-1234ze-E was treated with denatonium benzoate (DB) by dissolving the appropriate amount of benzoate in ethanol, and then adding a small amount of the DB/ethanol solution to the HFO-1234ze-E. When the samples were used as dusters, that is, spraying vapors to remove dirt, the operator could detect a bitter taste from the vapors at DB concentrations of about 900 ppm. The operator did not seem to detect a bitter taste from the vapors at 100 ppm DB concentrations.

### Example 2, Aerosol Composition of 44 wt % HFO-1336Mzz-E, Denatonium Benzoate, and 56 wt % Isobutane

The procedure of Example 1 was repeated, using a mixture of 44 wt % HFO-1336mzz-E and 56 wt % isobutane as the aerosol propellant. When the samples were used as dusters, that is, spraying vapors to remove dirt, the operator could detect a bitter taste from the vapors at DB concentrations of about 900 ppm. The operator did not seem to detect a bitter taste from the vapors at 100 ppm DB concentrations.

### Example 3. Aerosol Composition of 25 wt % HFO-1336Mzz-E, Denatonium Benzoate, and 75 wt % Dimethyl Ether

The procedure of Example 1 was repeated, using a mixture of 25 wt % HFO-1336mzz-E and 75 wt % dimethyl ether (DME) as the aerosol propellant. When the samples were used as dusters, that is, spraying vapors to remove dirt, the operator could detect a bitter taste from the vapors at DB concentrations of about 900 ppm. The operator did not seem to detect a bitter taste from the vapors at 100 ppm DB concentrations.

### Example 4. Aerosol Composition of 10 wt % HFO-1336Mzz-E, Denatonium Benzoate, and 90 wt % Isobutane

The procedure of Example 1 was repeated, using a mixture of 10 wt % HFO-1336mzz-E and 90 wt % isobutane as the aerosol propellant. When the samples were used as dusters, that is, spraying vapors to remove dirt, the operator could detect a bitter taste from the vapors at DB concentrations of about 900 ppm. The operator did not seem to detect a bitter taste from the vapors at 100 ppm DB concentrations.

### Example 5. Aerosol Composition of 20 wt % HFO-1336Mzz-E, Denatonium Benzoate, and 80 wt % HFC-152a

The procedure of Example 1 was repeated, using a mixture of 20 wt % HFO-1336mzz-E and 80 wt % HFC-152a as the aerosol propellant. Table 1 shows that when the samples were used as dusters, that is, spraying vapors to remove dirt, the operator could detect a bitter taste from the vapors at DB concentrations of about 900 ppm or higher. The operator did not seem to detect a bitter taste from the vapors at 36 ppm or 100 ppm DB concentrations.

TABLE 1
DB in HFO-1336mzz-E/HFC-152a (20:80)

| | Bitterant | |
|---|---|---|
| | Concentration | Bitter |
| Propellant | (ppm) | Taste? |
| HFO-1336mzz-E/HFC-152a (20:80) | 1180 | Yes |
| HFO-1336mzz-E/HFC-152a (20:80) | 909 | Yes |
| HFO-1336mzz-E/HFC-152a (20:80) | 100 | No |
| HFO-1336mzz-E/HFC-152a (20:80) | 36 | No |

### Example 6. Aerosol Composition of 25 wt % HFO-1336Mzz-Z, Denatonium Benzoate, and 75 wt % Isobutane

The procedure of Example 1 was repeated, using a mixture of 25 wt % HFO-1336mzz-Z and 75 wt % isobutane as the aerosol propellant. When the samples were used as dusters, that is, spraying vapors to remove dirt, the operator could detect a bitter taste from the vapors at DB concentrations of about 900 ppm. The operator did not seem to detect a bitter taste from the vapors at 100 ppm DB concentrations.

### Example 7. Aerosol Composition of 25 wt % HFO-1336Mzz-Z, Denatonium Benzoate, and 75 wt % Dimethyl Ether

The procedure of Example 1 was repeated, using a mixture of 25 wt % HFO-1336mzz-Z and 75 wt % dimethyl ether (DME) as the aerosol propellant. When the samples were used as dusters, that is, spraying vapors to remove dirt, the operator could detect a bitter taste from the vapors at DB concentrations of about 900 ppm. The operator did not seem to detect a bitter taste from the vapors at 100 ppm DB concentrations.

Examples 1 through 7 demonstrate that when the compositions of the present invention are used as dusters, the bitterant is not detected by the operator at concentrations of up to 100 ppm. Examples 1-7 also demonstrate that such liquefied-gas aerosol dusting compositions with 36-100 ppm denatonium benzoate do not interfere with normal product use.

### Example 8. Analysis of Bitterant in an Aerosol-Spray Under Normal Use Conditions

Example 8 further demonstrates that the liquefied-gas aerosol dusting compositions of the present invention with up to 50 ppm denatonium benzoate do not interfere with normal product use.

The objective of the study was to determine if potential users could detect the presence of bitterant in an aerosol-spray dust remover under normal use conditions. The products tested are shown in Table 2. To test each product, a technician sprayed the contents of an aerosol duster sample toward a 3×5 inch index card three times, for 5 seconds, each time from a distance of approximately 6 inches. The subject was told to sniff the air over the index card and record if they detected any scent or sensation. As seen from Table 2, under normal use conditions the bitterant could not be detected at concentrations of 10 or 50 ppm. Under the conditions employed in this study, representing normal use conditions, consumers of the duster products with the test concentrations of denatonium benzoate are thus no more likely to detect a scent or taste than those of the control product without denatonium benzoate.

TABLE 2

| | | Bitterant | |
|---|---|---|---|
| | | Concentration | Bitterant |
| Propellant | Bitterant | (ppm) | Detected? |
| HFO-1336mzz-E/HFC-152a (20:80) | DB | 10 | No |
| HFO-1336mzz-E/HFC-152a (20:80) | DB | 50 | No |
| HFO-1336mzz-E/isobutane (44:56) | DB | 10 | No |
| HFO-1336mzz-E/isobutane (44:56) | DB | 50 | No |
| HFO-1336mzz-E/HFC-152a (20:80) | None | 0 (Control) | No |
| HFO-1336mzz-E/isobutane (44:56) | None | 0 (Control) | No |

When the vapor discharged from an aerosol container contains about 50 to about 500 ppb of bitterant, the bitterant does not interfere with normal product use but is detectable in an inhalation abusive scenario so as to potentially discourage the practice. In the case of denatonium benzoate, 50 ppb of denatonium benzoate in the vapor is high enough to be detected if the vapor contacts the mouth, and more than about 500 ppb of denatonium benzoate in the vapor begins to interfere with normal use.

To achieve about 50 ppb to about 500 ppb in the vapor phase, the denatonium benzoate concentration in the liquid phase should be kept between about 5 ppm and 500 ppm. Further recognizing that denatonium benzoate will concentrate in the remaining liquid as the liquefied-gas aerosol dusting composition is consumed, the initial denatonium benzoate addition to the liquefied gas at manufacture shall be about 5 ppm to about 50 ppm to keep the denatonium benzoate concentration in the liquid phase between about 5 ppm and 500 ppm through 90% use. Therefore, initial denatonium benzoate addition to the liquefied gas in the range of 5 ppm to 50 ppm will yield a vapor concentration of 50 ppb to 500 ppb denatonium benzoate through 90% consumption of the liquefied-gas aerosol dusting composition, making the denatonium benzoate essentially undetectable during normal use, but detectable in an abuse scenario.

### Other Embodiments

1. In some embodiments, the present application provides an aerosol composition, comprising:
   i) a propellant component comprising one or more hydrohaloolefins; and
   ii) one or more bitterants.
2. The composition of embodiment 1, wherein the composition further comprises a solvent component, a carrier gas component, or a combination thereof
3. The composition of embodiment 2, wherein the solvent component is selected from an alcohol, a hydrocarbon, a hydrofluorocarbon, dimethyl ether, E-2-fluoro-3-(trifluoromethyl)oxirane, E-F-11E oxide, E-F-12E oxide, CFO-1112, or any mixture thereof.
4. The composition of embodiment 3, wherein the alcohol is selected from methanol, ethanol, propanol, and isopropanol.
5. The composition of embodiment 3 or 4, wherein the hydrocarbon is selected from propane, n-butane, isobutane, n-pentane, isopentane, and cyclopentane.
6. The composition of any one of embodiments 3 to 5, wherein the hydrofluorocarbon is selected from HFC-152a, HFC-134, and HFC-134a.
7. The composition of any one of embodiments 2 to 6, wherein the carrier gas component is selected from one of more of nitrogen, carbon dioxide, and nitrous oxide.
8. The composition of any one of embodiments 1 to 7, wherein the propellant component comprises one or more hydrofluoroolefins independently selected from HFO-1336mzz-E, HFO-1336mzz-Z, HFO-1234yf, HFO-1234ze-E, HFO-1234ze-Z, and HFO-1438ezy-E.
9. The composition of any one of embodiments 1 to 7, wherein the propellant component comprises one or more hydrofluorolefins selected from HFO-1336mzz-E and HFO-1336mzz-Z.
10. The composition of any one of embodiments 1 to 7, wherein the propellant component comprises a mixture of hydrofluoroolefins in an amount sufficient to form an azeotropic mixture or an azeotrope-like mixture.
11. The composition of any one of embodiments 1 to 7, wherein the propellant component comprises a mixture of:
   HFO-1336mzz-Z and HFO-1336mzz-E; or
   HFO-1336mzz-Z and HFO-1438ezy-E; or
   HFO-1336mzz-E and HFO-1438ezy-E;

wherein the mixture is an azeotrope-like mixture.
12. The composition of any one of embodiments 1 to 7, wherein the propellant component comprises one or more hydrochlorofluoroolefins selected from HCFO-1233zd-E, HCFO-1233zd-Z, HCFO-1224yd-E and HCFO-1224yd-Z.
13. The composition of any one of embodiments 1 to 7, wherein propellant component comprises a mixture of one or more hydrofluoroolefins selected from HFO-1336mzz-E, HFO-1336mzz-Z, HFO-1234yf, HFO-1234ze-E, HFO-1234ze-Z, and HFO-1438ezy-E, and one or more hydrochlorofluoroolefins selected from HCFO-1233zd-E, HCFO-1233zd-Z, HCFO-1224yd-E and HCFO-1224yd-Z.
14. The composition of embodiment 13, wherein the propellant component comprises a mixture of hydrofluoroolefins and hydrochlorofluoroolefins in an amount sufficient to form an azeotropic mixture or azeotrope-like mixture.
15. The composition of embodiment 13 or 14, wherein propellant component comprises a mixture of:
   HFO-1336mzz-Z and HCFO-1233zd; or
   HFO-1336mzz-E and HCFO-1233zd;

wherein the mixture is an azeotrope-like mixture.
16. The composition of any one of embodiments 2 to 15, wherein the propellant component and the solvent component are present in an amount sufficient to form an azeotropic mixture or an azeotrope-like mixture.
17. The composition of embodiment 16, wherein composition comprises a propellant component which is HFO-1336mzz-Z or HFO-1336mzz-E, and a solvent component selected from n-pentane, iso-pentane, cyclopentane, n-butane, isobutane, and dimethyl ether, wherein the propellant component and solvent component are present in an amount sufficient to form an azeotropic mixture or an azeotrope-like mixture.
18. The composition of any one of embodiments 1 to 17, wherein the one or more bitterants are each independently selected from denatonium benzoate, denatonium saccharide, denatonium 4-vinylbenzoate, sucrose octaacetate, gentian, naringin, limonin, quercetin analogs, phenolics, and quassin.
19. The composition of any one of embodiments 1 to 17, wherein the one or more bitterants are each independently selected from denatonium benzoate, denatonium saccharide, and sucrose octaacetate.
20. The composition of any one of embodiments 1 to 17, wherein the composition comprises a bitterant which is denatonium benzoate.
21. The composition of embodiment 1, wherein the composition comprises:
   a propellant component which is HFO-1234ze-E and a bitterant which is denatonium benzoate; or
   a propellant component which is HFO-1336mzz-E and a bitterant which is denatonium benzoate; or
   a propellant component which is HFO-1336mzz-Z and a bitterant which is denatonium benzoate.
22. The composition of embodiment 2, wherein the composition comprises:
   a propellant component which is HFO-1234ze-E, a bitterant which is denatonium benzoate, and a solvent component which is ethanol; or
   a propellant component which is HFO-1336mzz-E, a bitterant which is denatonium benzoate, and a solvent component which is isobutane; or
   a propellant component which is HFO-1336mzz-E, a bitterant which is denatonium benzoate, and a solvent component which is dimethyl ether; or
   a propellant component which is HFO-1336mzz-E, a bitterant which is denatonium benzoate, and a solvent component which is HFC-152a; or
   a propellant component which is HFO-1336mzz-Z, a bitterant which is denatonium benzoate, and a solvent component which is isobutane; or
   a propellant component which is HFO-1336mzz-Z, a bitterant which is denatonium benzoate, and a solvent component which is dimethyl ether.
23. The composition of any one of embodiments 1 to 22, wherein the composition comprises from about 5 to about 50 percent by weight of the hydrohaloolefin.
24. The composition of embodiment 23, wherein the composition comprises from about 95 to about 50 percent by weight of the solvent component.
25. The composition of embodiment 2, wherein the composition comprises:
   about 95 to about 99.99 percent by weight of a propellant component which is HFO-1234ze-E, about 5 to about 0.01 percent by weight of a solvent component which is ethanol, and a bitterant which is denatonium benzoate;
   about 40 to about 50 percent by weight of a propellant component which is HFO-1336mzz-E, about 60 to about 50 percent by weight of a solvent component which is isobutane, and a bitterant which is denatonium benzoate;
   about 20 to about 30 percent by weight of a propellant component which is HFO-1336mzz-E, about 80 to about 70 percent by weight of a solvent component which is dimethyl ether, and a bitterant which is denatonium benzoate;
   about 5 to about 15 percent by weight of a propellant component which is HFO-1336mzz-E, about 95 to about 85 percent by weight of a solvent component which is isobutane, and a bitterant which is denatonium benzoate;
   about 15 to about 25 percent by weight of a propellant component which is HFO-1336mzz-E, about 85 to about 75 percent by weight of a solvent component which is HFC-152a, and a bitterant which is denatonium benzoate;
   about 20 to about 30 percent by weight of a propellant component which is HFO-1336mzz-Z, about 80 to about 70 percent by weight of a solvent component which is isobutane, and a bitterant which is denatonium benzoate;
   about 20 to about 30 percent by weight of a propellant component which is HFO-1336mzz-Z, about 80 to about 70 percent by weight of a solvent component which is dimethyl ether, and a bitterant which is denatonium benzoate;
26. The composition of any one of embodiments 1 to 25, wherein the concentration of bitterant in the composition is from about 5 ppm to about 50 ppm.
27. The composition of any one of embodiments 1 to 26, wherein the propellant component is a liquid.
28. The composition of any one of embodiments 1 to 27, wherein the composition is a sprayable aerosol composition.
29. In some embodiments, the present application provides a method of cleaning a substrate, comprising spraying a composition of any one of embodiments 1 to 28 onto the substrate.
30. In some embodiments, the present application provides a method of cleaning an electronic device, comprising spraying a composition of any one of embodiments 1 to 27 onto the device.

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims. It should be appreciated by those persons having ordinary skill in the art(s) to which the present invention relates that any of the features described herein in respect of any particular aspect and/or embodiment of the present invention can be combined with one or more of any of the other features of any other aspects and/or embodiments of the present invention described herein, with modifications as appropriate to ensure compatibility of the combinations. Such combinations are considered to be part of the present invention contemplated by this disclosure.

What is claimed is:

1. An aerosol composition, comprising:
i) a propellant component comprising one or more hydrohaloolefins; and
ii) one or more bitterants.

2. The composition of claim 1, wherein the composition further comprises a solvent component, a carrier gas component, or a combination thereof.

3. The composition of claim 2, wherein the solvent component is selected from an alcohol, a hydrocarbon, a hydrofluorocarbon, dimethyl ether, E-2-fluoro-3-(trifluoromethyl)oxirane, E-F-11E oxide, E-F-12E oxide, CFO-1112, or any mixture thereof.

4. The composition of claim 3, wherein the alcohol is selected from methanol, ethanol, propanol, and isopropanol.

5. The composition of claim 3, wherein the hydrocarbon is selected from propane, n-butane, isobutane, n-pentane, isopentane, and cyclopentane.

6. The composition of claim 3, wherein the hydrofluorocarbon is selected from HFC-152a, HFC-134, and HFC-134a.

7. The composition of claim 2, wherein the carrier gas component is selected from one of more of nitrogen, carbon dioxide, and nitrous oxide.

8. The composition of claim 1, wherein the propellant component comprises one or more hydrofluoroolefins independently selected from HFO-1336mzz-E, HFO-1336mzz-Z, HFO-1234yf, HFO-1234ze-E, HFO-1234ze-Z, and HFO-1438ezy-E.

9. (canceled)

10. (canceled)

11. The composition of claim 8, wherein the propellant component comprises a mixture of:
HFO-1336mzz-Z and HFO-1336mzz-E; or
HFO-1336mzz-Z and HFO-1438ezy-E; or
HFO-1336mzz-E and HFO-1438ezy-E;
wherein the mixture is an azeotrope-like mixture.

12. The composition of claim 1, wherein the propellant component comprises one or more hydrochlorofluoroolefins selected from HCFO-1233zd-E, HCFO-1233zd-Z, HCFO-1224yd-E and HCFO-1224yd-Z.

13. The composition of claim 1, wherein propellant component comprises a mixture of one or more hydrofluoroolefins selected from HFO-1336mzz-E, HFO-1336mzz-Z, HFO-1234yf, HFO-1234ze-E, HFO-1234ze-Z, and HFO-1438ezy-E, and one or more hydrochlorofluoroolefins selected from HCFO-1233zd-E, HCFO-1233zd-Z, HCFO-1224yd-E and HCFO-1224yd-Z.

14. (canceled)

15. The composition of claim 13, wherein propellant component comprises a mixture of:
HFO-1336mzz-Z and HCFO-1233zd; or
HFO-1336mzz-E and HCFO-1233zd;
wherein the mixture is an azeotrope-like mixture.

16. The composition of claim 2, wherein the propellant component and the solvent component are present in an amount sufficient to form an azeotropic mixture or an azeotrope-like mixture.

17. The composition of claim 16, wherein composition comprises a propellant component which is HFO-1336mzz-Z or HFO-1336mzz-E, and a solvent component selected from n-pentane, iso-pentane, cyclopentane, n-butane, isobutane, and dimethyl ether, wherein the propellant component and solvent component are present in an amount sufficient to form an azeotropic mixture or an azeotrope-like mixture.

18. The composition of claim 1, wherein the one or more bitterants are each independently selected from denatonium benzoate, denatonium saccharide, denatonium 4-vinylbenzoate, sucrose octaacetate, gentian, naringin, limonin, quercetin analogs, phenolics, and quassin.

19. (canceled)

20. (canceled)

21. The composition of claim 1, wherein the composition comprises:
a propellant component which is HFO-1234ze-E and a bitterant which is denatonium benzoate; or
a propellant component which is HFO-1336mzz-E and a bitterant which is denatonium benzoate; or
a propellant component which is HFO-1336mzz-Z and a bitterant which is denatonium benzoate.

22. The composition of claim 2, wherein the composition comprises:
a propellant component which is HFO-1234ze-E, a bitterant which is denatonium benzoate, and a solvent component which is ethanol; or
a propellant component which is HFO-1336mzz-E, a bitterant which is denatonium benzoate, and a solvent component which is isobutane; or
a propellant component which is HFO-1336mzz-E, a bitterant which is denatonium benzoate, and a solvent component which is dimethyl ether; or
a propellant component which is HFO-1336mzz-E, a bitterant which is denatonium benzoate, and a solvent component which is HFC-152a; or
a propellant component which is HFO-1336mzz-Z, a bitterant which is denatonium benzoate, and a solvent component which is isobutane; or
a propellant component which is HFO-1336mzz-Z, a bitterant which is denatonium benzoate, and a solvent component which is dimethyl ether.

23. (canceled)

24. (canceled)

25. The composition of claim 2, wherein the composition comprises:
about 95 to about 99.99 percent by weight of a propellant component which is HFO-1234ze-E, about 5 to about 0.01 percent by weight of a solvent component which is ethanol, and a bitterant which is denatonium benzoate;
about 40 to about 50 percent by weight of a propellant component which is HFO-1336mzz-E, about 60 to about 50 percent by weight of a solvent component which is isobutane, and a bitterant which is denatonium benzoate;
about 20 to about 30 percent by weight of a propellant component which is HFO-1336mzz-E, about 80 to about 70 percent by weight of a solvent component which is dimethyl ether, and a bitterant which is denatonium benzoate;
about 5 to about 15 percent by weight of a propellant component which is HFO-1336mzz-E, about 95 to about 85 percent by weight of a solvent component which is isobutane, and a bitterant which is denatonium benzoate;
about 15 to about 25 percent by weight of a propellant component which is HFO-1336mzz-E, about 85 to about 75 percent by weight of a solvent component which is HFC-152a, and a bitterant which is denatonium benzoate;
about 20 to about 30 percent by weight of a propellant component which is HFO-1336mzz-Z, about 80 to about 70 percent by weight of a solvent component which is isobutane, and a bitterant which is denatonium benzoate;
about 20 to about 30 percent by weight of a propellant component which is HFO-1336mzz-Z, about 80 to about 70 percent by weight of a solvent component which is dimethyl ether, and a bitterant which is denatonium benzoate;

26. (canceled)

27. (canceled)

28. The composition of claim 1, wherein the composition is a sprayable aerosol composition.

29. A method of cleaning a substrate, comprising spraying a composition of claim 28 onto the substrate.

30. (canceled)
